(19) United States
(12) Patent Application Publication
(10) Pub. No.: US 2023/0278401 A1
(43) Pub. Date: Sep. 7, 2023

(54) Air-Conditioner for Vehicle

(71) Applicants: Hyundai Motor Company, Seoul (KR); Kia Corporation, Seoul (KR)

(72) Inventors: Byeong Moo Jang, Suwon-si (KR); Young Tae Song, Gwangmyeong-si (KR); Jae Sik Choi, Suwon-si (KR); Yun Chang Kim, Seoul (KR)

(21) Appl. No.: 17/896,369

(22) Filed: Aug. 26, 2022

(30) Foreign Application Priority Data
Mar. 7, 2022 (KR) 10-2022-0028823

(51) Int. Cl. B60H 1/34

(52) U.S. Cl. CPC B60H 1/3414

(57) ABSTRACT

An embodiment air conditioner for a vehicle includes a blower unit on an outer surface of a dash panel, the outer surface being opposite an inner surface facing an interior space of the vehicle, the blower unit including a blower fan and a filter, an air conditioning unit on the outer surface of the dash panel and coupled to a side of the blower unit between the blower unit and the interior space of the vehicle, and a distribution unit disposed on the inner surface of the dash panel and located between the air conditioning unit and air conditioning ducts provided in the interior space of the vehicle, wherein each of the blower unit, the air conditioning unit, and the distribution unit is coupled to be individually detachable.

### CROSS-REFERENCE TO RELATED APPLICATIONS

This application claims the benefit of Korean Patent Application No. 10-2022-0028823, filed on Mar. 7, 2022, which application is hereby incorporated herein by this reference.

### TECHNICAL FIELD

The present disclosure relates to an air conditioner for a vehicle.

### BACKGROUND

In general, air conditioners are installed in vehicles, and heating and cooling systems are provided to provide cold air or warm air to an interior. These air conditioners generally use a heat pump system. In particular, since eco-friendly vehicles such as electric vehicles and fuel cell vehicles do not have engine coolant, heat pump air conditioners capable of heating and cooling the inside of the vehicle even without engine coolant are mainly used.

General heat pump air conditioners include an air conditioning unit (HVAC) provided with an air inlet and an air outlet, a blower unit installed on the air inlet of the air conditioning unit, and a distribution unit connected to the air outlet of the air conditioning unit to distribute air to each point inside a vehicle.

An evaporator for a cooling operation, a condenser and a heater for a heating operation, etc. are provided inside the air conditioning unit to generate cold and warm air, and the cold and warm air generated by the air conditioning unit are distributed to the inside of the vehicle through the distribution unit.

The conventional air conditioners for a vehicle have a problem in that the air conditioning unit and the distribution unit in addition to the blower unit are disposed inside the vehicle with respect to the dashboard for the vehicle, thereby occupying a large amount of an inside space.

In order to solve this problem, the entire configuration of the air conditioner for a vehicle has been disposed outside the vehicle where the engine room is located with respect to the dashboard for the vehicle, but in this case, there is a problem in that a separate novel duct structure should be developed to form a structure connected to the air conditioning duct located on the rear duct of a vehicle because the distribution unit is disposed outside the vehicle.

Furthermore, recently, vehicles in which a console is provided therein are increasing to improve user convenience, and the vehicles thus provided with the console have a problem in that the inside structure is more complicated.

Meanwhile, the conventional air conditioners for a vehicle have the blower unit installed on the air inlet of the air conditioning unit. Accordingly, when foreign substances such as fallen leaves or dust accumulate on the air inlet or the filter of the blower unit through which exterior air flows and the blower unit needs to be replaced, the blower unit should be replaced after separating the entire air conditioning unit from the vehicle.

In addition, since the blower unit is installed inside the air conditioning unit, there is a problem in that it is not possible to secure the sufficient space to form the flow path of air through which air flows inside the air conditioning unit, and the structure of the flow path of air is complicated, and as the inside structure is complicated, it is difficult to individually control the temperature of the air discharged to each point of the vehicle.

The matters explained as the background art are for the purpose of enhancing the understanding of the background of the present disclosure and should not be taken as acknowledging that they correspond to the related art already known to those skilled in the art.

### SUMMARY

The present disclosure relates to an air conditioner for a vehicle. Particular embodiments relate to an air conditioner for a vehicle that may separate a blower unit from an HVAC while improving an inside structure of the HVAC and individually detach each of the HVAC, the blower unit, and a distribution unit even while optimizing the arrangement of the HVAC, the blower unit, and the distribution unit.

Embodiments of the present disclosure can solve problems in the art, and an embodiment of the present disclosure provides an air conditioner for a vehicle, which individually controls a temperature of air discharged into a vehicle by improving an inside structure of an HVAC, disposes the HVAC and a blower unit outside the vehicle and disposes a distribution unit inside the vehicle with respect to a dash panel for the vehicle to maximize the use of an inside space of the vehicle, and individually detaches each of the HVAC, the blower unit, and the distribution unit to improve a manufacturing process and efficiency of service.

An air conditioner for a vehicle includes a blower unit disposed on an outer surface of a dash panel for the vehicle opposite to an inside space, and provided with a blower fan and a filter, an air conditioning unit disposed on the outer surface of the dash panel for the vehicle opposite to the inside space, coupled to a side of the blower unit to introduce air from the blower unit, and adjusting a temperature of the introduced air, and a distribution unit disposed on an inner surface of the dash panel for the vehicle facing the inside space, introducing air whose temperature has been adjusted through the air conditioning unit, and distributing the introduced air to each point of the inside space of the vehicle, in which each of the blower unit, the air conditioning unit, and the distribution unit is coupled to be individually detachable.

The air conditioning unit of the air conditioner for the vehicle according to embodiments of the present disclosure may have a cooler and a heater provided therein, and may be provided with a cold wind flow path installed with the cooler and a warm wind flow path installed with the heater, so that the air introduced from the blower unit may be divided into cold air and warm air and discharged along each flow path.

The air conditioning unit of the air conditioner for the vehicle according to embodiments of the present disclosure may further include a door unit disposed between the cold wind flow path and the warm wind flow path and individually provided on an inlet and an outlet of each flow path to adjust an opening amount of the air flowing into each flow path.

The cold wind flow path and the warm wind flow path of the air conditioner for the vehicle according to embodiments of the present disclosure may have a separation plate formed on each central portion and may be separated into a left air flow path and a right air flow path, the left air flow path communicating with an air conditioning duct disposed on a right seat of the vehicle and the right air flow path communicating with an air conditioning duct disposed on a left seat of the vehicle, and the door unit may be individually provided on an inlet and an outlet of each of the left air flow path and the right air flow path.

The cold wind flow path of the air conditioner for the vehicle according to embodiments of the present disclosure may include a first flow path disposed above the warm wind flow path to communicate with an air conditioning duct disposed on a front seat of the vehicle and a second flow path disposed below the warm wind flow path to communicate with an air conditioning duct disposed on a rear seat of a vehicle.

The distribution unit of the air conditioner for the vehicle according to embodiments of the present disclosure may include a first distribution unit connected to the air conditioning duct disposed on the front seat of the vehicle and a second distribution unit connected to the air conditioning duct disposed on the rear seat of the vehicle.

The first distribution unit and the second distribution unit of the air conditioner for the vehicle according to embodiments of the present disclosure may have a separation plate formed on each central portion and may be separated into a left distribution unit and a right distribution unit, the left distribution unit being connected to an air conditioning duct disposed on a right seat of the vehicle and the right distribution unit being connected to an air conditioning duct disposed on a left seat of the vehicle.

The door unit of the air conditioner for the vehicle according to embodiments of the present disclosure may include a first door unit disposed between the first flow path and each inlet of the warm wind flow path, a second door unit disposed between the first flow path and each outlet of the warm wind flow path, and a third door unit disposed between the warm wind flow path and the second flow path.

The door unit of the air conditioner for the vehicle according to embodiments of the present disclosure may be formed in a plate-shaped flat shape and installed to be slidable vertically to adjust an opening amount of the air flowing into the cold wind flow path and the warm wind flow path in a sliding direction.

The door unit of the air conditioner for the vehicle according to embodiments of the present disclosure may be formed in a fan-shaped dome shape or a propeller-shaped rotary shape and rotatably installed to adjust an opening amount of the air flowing into the cold wind flow path and the warm wind flow path according to a rotation angle.

The heater of the air conditioner for the vehicle according to embodiments of the present disclosure may include a condenser and a positive temperature coefficient (PTC) heater, the PTC heater being separated from the air conditioning unit and provided in the distribution unit.

According to the air conditioner for the vehicle according to embodiments of the present disclosure, it is possible to dispose the HVAC and the blower unit outside the vehicle and dispose the distribution unit inside the vehicle with respect to the dash panel for the vehicle to maximize the use of the inside space of the vehicle, and individually detach each of the HVAC, the blower unit, and the distribution unit to improve the manufacturing process and the efficiency of service.

In addition, it is possible to form the plurality of flow paths separated in the up-down direction and the left-right direction inside the HVAC and have the door unit configured to adjust the opening amount of the air flowing into each flow path, thereby individually controlling the temperatures of the air discharged to the air conditioning ducts disposed on the front and rear seats and the left and right seats for the vehicle.

### BRIEF DESCRIPTION OF THE DRAWINGS

The above and other objects, features and other advantages of embodiments of the present disclosure will be more clearly understood from the following detailed description when taken in conjunction with the accompanying drawings, in which:

FIG. 1 is a diagram showing an inside structure of an air conditioning unit and a distribution unit according to one embodiment of the present disclosure;

FIG. 2 is a diagram showing an inside structure of a blower unit according to one embodiment of the present disclosure;

FIG. 3 is a diagram schematically showing an arrangement state of the blower unit, the air conditioning unit, and the distribution unit according to one embodiment of the present disclosure;

FIG. 4 is a diagram schematically showing that an air conditioner for a vehicle according to one embodiment of the present disclosure is installed inside the vehicle in the state of FIG. 3;

FIG. 5 is a cross-sectional diagram taken along line A-A of FIG. 1;

FIG. 6 is a cross-sectional diagram showing anther embodiment of FIG. 5; and

FIG. 7 is a diagram showing inside structures of an air conditioning unit and the distribution unit according to another embodiment of the present disclosure.

### DETAILED DESCRIPTION OF ILLUSTRATIVE EMBODIMENTS

Throughout this specification, when a certain part “includes” a certain component, it means that other components may be further included, not precluding other components, unless otherwise stated especially.

In addition, terms such as first and/or second may be used to describe various components, but these terms are only for distinguishing the component from other components, and for example, a first component may be named a second component, and similarly, the second component may also be named the first component without departing from the scope according to the concept of the present disclosure.

Hereinafter, the configuration and operating principle of various embodiments of the disclosed disclosure will be described in detail with reference to the accompanying drawings.

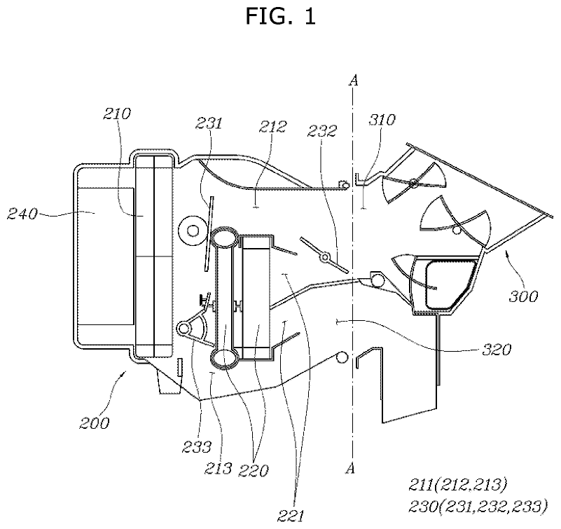

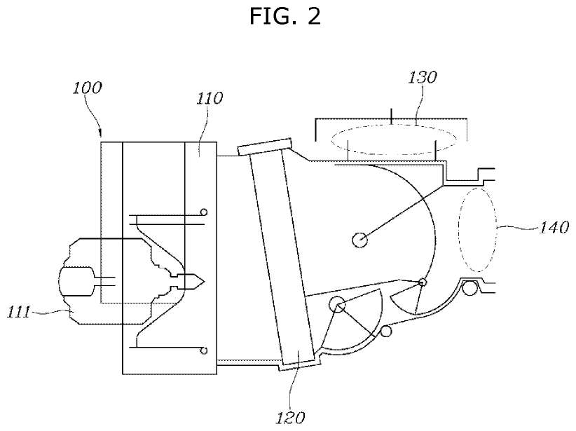

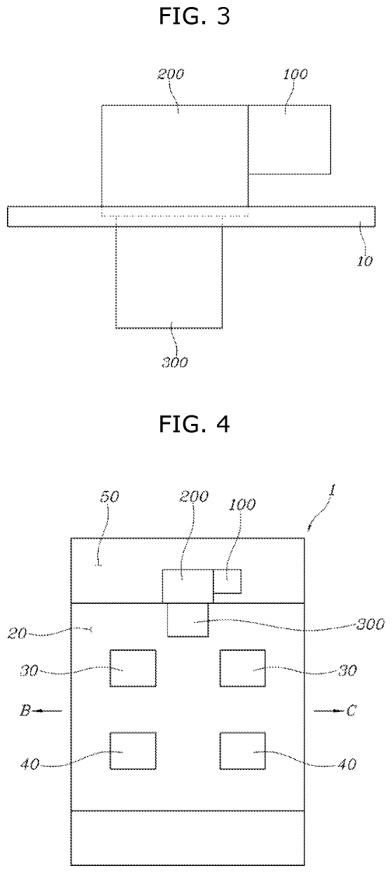

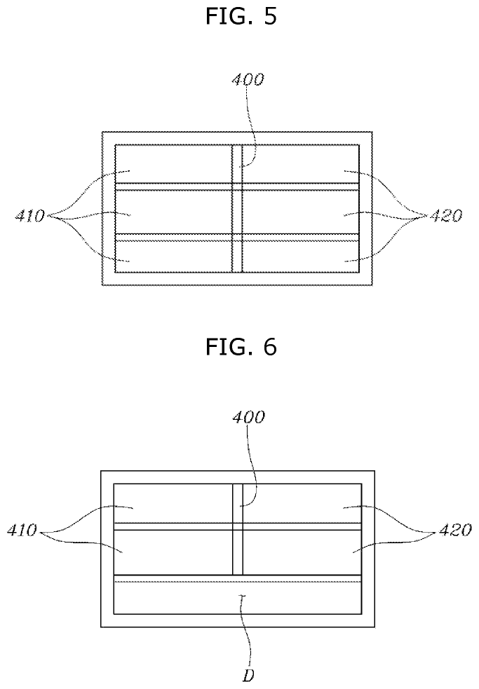

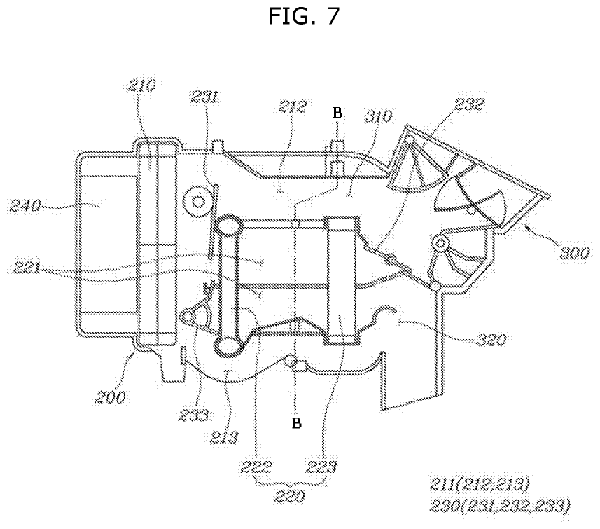

FIG. 1 is a diagram showing an inside structure of an air conditioning unit 200 and a distribution unit 300 according to one embodiment of the present disclosure, FIG. 2 is a diagram showing an inside structure of a blower unit 100 according to one embodiment of the present disclosure, FIG. 3 is a diagram schematically showing an arrangement state of the blower unit 100, the air conditioning unit 200, and the distribution unit 300 according to one embodiment of the present disclosure, FIG. 4 is a diagram schematically showing that an air conditioner for a vehicle 1 according to one embodiment of the present disclosure is installed inside the vehicle 1 in the state of FIG. 3, FIG. 5 is a cross-sectional diagram taken along line A-A of FIG. 1, FIG. 6 is a cross-sectional diagram showing anther embodiment of FIG. 5, and FIG. 7 is a diagram showing inside structures of an air conditioning unit and the distribution unit according to another embodiment of the present disclosure.

Referring to FIGS. 1 to 4, the air conditioner for the vehicle 1 according to embodiments of the present disclosure includes the blower unit 100 disposed on an outer surface of a dash panel 10 for the vehicle 1 opposite to an inside space 20 and provided with a blower fan no and a filter 120, the air conditioning unit 200 disposed on the outer surface of the dash panel 10 for the vehicle 1 opposite to the inside space 20, coupled to a side of the blower unit 100 to introduce air from the blower unit 100, and adjusting a temperature of the introduced air, and the distribution unit 300 disposed on an inner surface of the dash panel 10 for the vehicle 1 facing the inside space 20, introducing the air whose temperature has been adjusted through the air conditioning unit 200, and distributing the introduced air to each point of the inside space 20 of the vehicle 1, in which each of the blower unit 100, the air conditioning unit 200, and the distribution unit 300 are coupled to be individually detachable.

In order to help the understanding of embodiments of the present disclosure, key features of the components of embodiments of the present disclosure will be described together while briefly describing the inside structure of the general air conditioner for the vehicle 1.

A general heat pump air conditioner includes the air conditioning unit (HVAC) 200 provided with an air inlet and an air outlet, the blower unit 100 installed on the air inlet of the air conditioning unit 200, and the distribution unit 300 connected to the air outlet of the air conditioning unit 200 to distribute air to each point inside the vehicle 1.

An evaporator for a cooling operation, a condenser and a heater for a heating operation, etc. are provided inside the air conditioning unit 200 to generate cold and warm air, and the cold and warm air generated by the air conditioning unit 200 is distributed into the vehicle 1 through the distribution unit 300.

In other words, the air conditioner for the vehicle 1 according to embodiments of the present disclosure includes the blower unit 100, the air conditioning unit 200, and the distribution unit 300 as basic components.

For reference, here, it may be understood that ‘each point inside the vehicle 1’ means a point where an air conditioning duct that receives cold and warm air from the air conditioner to discharge the cold and warm air into the vehicle is installed, and more specifically, means a point where the air conditioning ducts installed inside seats (left and right seats or front and rear seats) for the vehicle 1 and disposed to provide the air with a proper temperature to the user seated on the seat are installed.

However, the air conditioning duct installed at each point inside the vehicle 1 may also be installed outside the seat, such as the front or side of the seat, other than inside the seat, depending on a change in design, and accordingly, it is preferable to understand that the air conditioning duct in this specification is installed around the seat for the vehicle 1 and disposed to provide the air with the proper temperature to the user seated on the seat.

Meanwhile, the conventional air conditioner for the vehicle 1 has a problem in that the air conditioning unit 200 and the distribution unit 300 in addition to the blower unit 100 are disposed inside the vehicle with respect to a dashboard or the dash panel 10 for the vehicle 1 to occupy a large amount of the inside space 20.

On the other hand, there is a problem in that when the air conditioning unit 200 and the distribution unit 300 in addition to the blower unit 100 are disposed outside the vehicle 1 where an engine room 50 is located with respect to the dash panel 10 for the vehicle 1, a separate novel duct structure should be developed to form a structure connected to the air conditioning duct located on a rear seat 40 for the vehicle 1 as the distribution unit 300 is disposed outside the vehicle.

Accordingly, the air conditioner for the vehicle 1 according to embodiments of the present disclosure has the air conditioning unit 200 and the blower unit 100 disposed outside the vehicle and has the distribution unit 300 disposed inside the vehicle with respect to the dash panel 10 for the vehicle 1 to maximize the use of the inside space 20 of the vehicle 1.

In addition, since the conventional air conditioner for the vehicle 1 has the blower unit 100 installed on the air inlet of the air conditioning unit 200, the blower unit 100 should be replaced after separating the entire air conditioning unit 200 from the vehicle 1 when service of the blower unit 100 is required, it is not possible to secure a sufficient space to form a flow path of air through which the air flows inside the air conditioning unit 200, and it is difficult to individually control the temperature of the air discharged to each point of the vehicle 1 as the structure of the flow path of the air is complicated.

Accordingly, the air conditioner for the vehicle 1 according to embodiments of the present disclosure enables the service of the blower unit 100 by separating the air conditioning unit 200 and the blower unit 100 even without separating the air conditioning unit 200, and sufficiently secures the inside space of the air conditioning unit 200 to simplify the structure of the complicated flow path of the air, thereby not only facilitating the manufacturing process but also easily implementing the structure in which the temperature of the air discharged to each point of the vehicle 1 is individually controlled.

Hereinafter, the technical features of each component of embodiments of the present disclosure will be described in more detail with reference to FIGS. 1 to 4.

Specifically, referring to FIG. 2, the blower unit 100 of the air conditioner of the vehicle 1 according to embodiments of the present disclosure is formed with an outside air inlet 130 into which outside air flows and an inside air inlet 140 into which inside air flows, and as the blower fan no driven by a blower motor 111 is rotated, a pressure difference occurs, so that air flows into the blower unit 100. In addition, the air introduced through each inlet passes through the filter 120 to filter foreign substances.

For reference, here, it may be understood that the inside air inlet 140 is to flow the inside air into the air conditioner when the air conditioner is driven in an inside air circulation mode, and the outside air inlet 130 is to flow the outside air into the air conditioner when the air conditioner is driven in an outside air circulation mode. In other words, the air conditioner of the vehicle 1 introduces inside air or outside air to discharge the cold and warm air into the vehicle after cooling or heating.

Subsequently, referring to FIG. 1, the air introduced by the blower unit 100 flows into the air conditioning unit 200 through a connection flow path 240 of the air conditioning unit 200. The air flowing into the air conditioning unit 200 becomes cold air in a low-temperature state while passing through a cooler 210, and the cold air in the low-temperature state is discharged to each point of the vehicle 1 through the distribution unit 300, so that cooling is performed.

Meanwhile, the cold air in the low-temperature state may be changed to warm air in a high-temperature state while passing through a heater 220, and the warm air is discharged to each point of the vehicle 1 through the distribution unit 300, so that heating is performed.

In other words, the air conditioning unit 200 of the air conditioner for the vehicle 1 according to embodiments of the present disclosure may have the cooler 210 and the heater 220 provided therein, and may be provided with a cold wind flow path 211 installed with the cooler 210 and a warm wind flow path 221 installed with the heater 220 so that the air introduced from the blower unit 100 along each flow path may be divided into cold air and warm air and discharged along each flow path.

Here, the cooler 210 may include an evaporator, and the heater 220 may include a capacitor and a heater. In particular, FIG. 1 shows a capacitor and a positive temperature coefficient (PTC) heater as the heater 220. Here, the PTC heater is a heater using a PTC element, which is a ceramic-based semiconductor element, and is generally used as an auxiliary heater.

This PTC element has a property in which a resistance is increased as the temperature rises, and when the temperature rises above a specific temperature, a current is blocked by the increased resistance. Accordingly, there are advantages in that the PTC element is quickly heated by consuming the maximum power initially, and as the temperature rises, the power consumption gradually decreases, thereby reducing a heating rate. Accordingly, there is no need for an outside feedback control because the PTC element itself performs a sensor function, thereby fundamentally blocking the risk of overheating to improve safety.

Meanwhile, referring to FIGS. 3 and 4, the blower unit 100, the air conditioning unit 200, and the distribution unit 300 of the air conditioner of the vehicle 1 according to embodiments of the present disclosure are individually manufactured and formed to be detachable. In other words, the air conditioning unit 200 is coupled to the side of the blower unit 100, and the air conditioning unit 200 and the distribution unit 300 are mounted on opposite sides with respect to the dash panel 10 of the vehicle 1 and coupled to each other.

Accordingly, when service of the blower unit 100 is required, it is possible to remove and replace only the blower unit 100 even without separating the air conditioning unit 200 from the vehicle 1, thereby enabling the service to be performed more conveniently. Furthermore, when service of the air conditioning unit 200 and the distribution unit 300 is required, it is possible to remove and replace only the unit having the problem.

In addition, the blower unit 100 and the air conditioning unit 200 are disposed outside the vehicle, and the distribution unit 300 is disposed inside the vehicle with respect to the dash panel 10 for the vehicle 1. Here, the outside of the vehicle 1 means a region in which the engine room 50 of the vehicle 1 is located, and the inside thereof means the same region as the space in which the user of the vehicle 1 rides. In other words, the dash panel 10 for the vehicle 1 may be located in along the line A-A in FIG. 1, and it may be understood that the left side means the outside and the right side means the inside with respect to the line A-A.

As described above, it is possible to dispose the air conditioning unit 200 and the blower unit 100 other than the distribution unit 300 outside the vehicle, thereby not only maximizing the user of the inside space 20 of the vehicle 1 but also more simply implementing the structure connected to the air conditioning duct located on a rear seat 40 of the vehicle 1 even when a separate novel duct structure through the distribution unit 300 disposed inside the vehicle is not developed.

Meanwhile, the air conditioning unit 200 of the air conditioner for the vehicle 1 according to embodiments of the present disclosure may further include a door unit 230 disposed between the cold wind flow path 211 and the warm wind flow path 221 and individually provided on an inlet and an outlet of each flow path to adjust the opening amount of the air flowing into each flow path.

In other words, the air conditioning unit 200 can adjust the opening amount of each of the cold air and the warm air through the door unit 230 so that the cold air and the warm air are appropriately mixed and then flow into the distribution unit 300, thereby providing the air with a proper temperature to the user of the vehicle 1.

Here, the door unit 230 may include a first door unit 231, a second door unit 232, and a third door unit 233, which will be described in detail later.

FIG. 5 is a cross-sectional diagram along the line A-A of FIG. 1, and FIG. 6 is a cross-sectional diagram showing another embodiment of FIG. 5. Here, FIG. 5 shows a cross-sectional diagram along the line A-A in a state of being viewed from the inside toward outside of the vehicle.

Referring to FIGS. 5 and 6, the cold wind flow path 211 and the warm wind flow path 221 of the air conditioner for the vehicle 1 according to embodiments of the present disclosure are formed with a separation plate 400 on each central portion and divided into a left air flow path 410 and a right air flow path 420, and the left air flow path 410 may communicate with the air conditioning duct disposed on the left seat of the vehicle 1, the right air flow path 420 may communicate with the air duct disposed on the right seat of the vehicle 1, and the door unit 230 may be individually provided on an inlet and an outlet of each of the left air flow path 410 and the right air flow path 420.

In other words, the separation plate 400 formed on the central portion of each of the cold wind flow path 211 and the warm wind flow path 221 separates each flow path into the left air flow path 410 and the right air flow path 420 so that each flow path may communicate with the air conditioning duct disposed on the left seat or the right seat of the vehicle 1.

In addition, the door unit 230 may be individually provided on the inlet and the outlet of the left air flow path 410 and the right air flow path 420 to individually control the temperatures of the air discharged to the air conditioning ducts disposed on the left and right seats of the vehicle 1 through the door unit 230.

For example, when air is intended to be discharged only to the left seat, the door unit 230 provided on the inlet and outlet of the left air flow path 410 is opened, and the door unit 230 provided on the inlet and outlet of the right air flow path 420 is closed. On the other hand, when air is intended to be discharged only to the right seat, the door unit 230 provided on the inlet and outlet of the right air flow path 420 is opened, and the door unit 230 provided on the inlet and outlet of the left air flow path 410 is closed.

As a result, as described above, it is possible to more simply implement the structure in which the temperatures of the air discharged to the air conditioning ducts disposed on the left and right seats of the vehicle 1 are individually controlled by individually adjusting the door unit 230.

For reference, here, it may be understood that the left seat of the vehicle 1 includes all of the front and rear seats located on the left as the seat located on the left (B) of the vehicle 1, and the right seat of the vehicle 1 includes all of the front and rear seats located on the right as the seat located on the right (C) of the vehicle 1 (see FIG. 4).

In addition, it may be understood that the left air flow path 410 includes both the cold wind flow path 211 and the warm wind flow path 221 located on the left of the vehicle 1, and the right air flow path 420 includes both the cold wind flow path 211 and the warm wind flow path 221 located on the right of the vehicle 1.

At this time, it may be seen that FIG. 1 shows that the line A-A has the warm wind flow path 221 divided into top and bottom, but FIG. 5 shows that the warm wind flow path 221 is not divided into top and bottom. This is merely a difference due to simply expressing the line A-A to help the understanding of embodiments of the present disclosure, and the content of the present disclosure should not be limited or otherwise interpreted by the shapes of these drawings.

In addition, as shown in region D of FIG. 6, the cold wind flow path 211 located on a lower end of the warm wind flow path 221 may be formed in a structure in which the separation plate 400 is removed. It may be understood that this is to quickly air condition the entire inside of the vehicle 1 in some cases. As will be described below, the cold wind flow path 211 located on the lower end of the warm wind flow path 221 may communicate with the air conditioning duct disposed on the rear seat 40.

Accordingly, when the internal structure of the air conditioner of the vehicle 1 according to embodiments of the present disclosure is formed like the region D of FIG. 6, the air provided to the rear seat 40 may not be individually controlled for each of the rear seat 40 located on the left (B) of the vehicle 1 and the rear seat 40 located on the right (C) of the vehicle 1.

However, the rear seat 40 has a relatively long flow path of air compared to the front seat 30, so that it is necessary to form a structure like the region D of FIG. 6 in order to quickly air condition the entire inside of the vehicle 1. In other words, when air is intended to be provided to the rear seat 40, the entire inside of the vehicle 1 may be quickly air conditioned by adopting the structure like the region D of FIG. 6 with the separation plate 400 removed, as necessary.

FIG. 1 is a diagram showing the internal structures of the air conditioning unit 200 and the distribution unit 300 according to one embodiment of the present disclosure.

Referring to FIG. 1, the cold wind flow path 211 of the air conditioner of the vehicle 1 according to embodiments of the present disclosure may include a first flow path 212 disposed above the warm wind flow path 221 to communicate with the air conditioning duct disposed on the front seat 30 of the vehicle 1 and a second flow path 213 disposed below the warm wind flow path 221 to communicate with the air conditioning duct disposed on the rear seat 40 of the vehicle 1.

In addition, the door unit 230 of the air conditioner for the vehicle 1 according to embodiments of the present disclosure may include the first door unit 231 disposed between the first flow path 212 and each inlet of the warm wind flow path 221, the second door unit 232 disposed between the first flow path 212 and each outlet of the warm wind flow path 221, and the third door unit 233 disposed between the warm wind flow path 221 and the second flow path 213.

In other words, the cold wind flow path 211 includes the first flow path 212 disposed above the warm wind flow path 221 and the second flow path 213 disposed below the warm wind flow path 221, and as mentioned above, the second flow path 213 disposed below the warm wind flow path 221 communicates with the air conditioning duct disposed on the rear seat 40 of the vehicle 1. The first flow path 212 disposed above the warm wind flow path 221 communicates with the air conditioning duct disposed on the front seat 30 of the vehicle 1.

In addition, the door unit 230 may include the first door unit 231, the second door unit 232, and the third door unit 233 disposed as described above to individually control the temperature of the air discharged to the air conditioning ducts disposed on the front and rear seats of the vehicle 1 through each of the door units 231, 232, 233.

For example, when the air in a medium temperature state where cold air and warm air are mixed is intended to be provided to the front seat 30 and only the cold air is intended to be provided to the rear seat 40, the first door unit 231 adjusts both the first flow path 212 and the inlet of the warm wind flow path 221 to be opened, the second door unit 232 adjusts the first flow path 212 and the outlet of the warm wind flow path 221 to be opened so that the cold air and the warm air are mixed and discharged to the distribution unit 300, and the third door unit 233 adjusts the second flow path 213 to be opened and the warm wind flow path 221 to be closed so that only the cold air is discharged to the distribution unit 300. This is the same as the state where the door unit 230 is shown in FIG. 1.

On the other hand, when only the cold air is intended to be provided to the front seat 30 and only the warm air is intended to be provided to the rear seat 40, the first door unit 231 is slid downward from the state shown in FIG. 1 to close the warm wind flow path 221 and open only the first flow path 212, the second door unit 232 is rotated counterclockwise in the state shown in FIG. 1 to close the warm wind flow path 221 and minimize the interference of the flow of the cold air passing through the cold wind flow path 211, and the third door unit 233 is rotated clockwise in the state shown in FIG. 1 to close the second flow path 213 and open only the warm wind flow path 221.

As a result, as described above, it is possible to individually adjust the first door unit 231, the second door unit 232, and the third door unit 233, thereby simply implementing the structure in which the temperatures of the air discharged to the air conditioning ducts disposed on the front and rear seats of the vehicle 1 are individually controlled.

Furthermore, the distribution unit 300 of the air conditioner for the vehicle 1 according to embodiments of the present disclosure may include a first distribution unit 310 connected to the air conditioning duct disposed on the front seat 30 of the vehicle 1 and a second distribution unit 320 connected to the air conditioning duct disposed on the rear seat 40 of the vehicle 1.

In other words, the first distribution unit 310 of the distribution unit 300 has one side connected to the first flow path 212 and each outlet of the warm wind flow path 221 and the other side connected to the air conditioning duct disposed on the front seat 30 of the vehicle 1 so that the air passing through the first door unit 231 and the second door unit 232 may be provided to the front seat 30 of the vehicle 1.

Likewise, the second distribution unit 320 of the distribution unit 300 has one side connected to the warm wind flow path 221 and the second flow path 213 and the other side connected to the air conditioning duct disposed on the rear seat 40 of the vehicle 1 so that the air passing through the third door unit 233 may be provided to the rear seat 40 of the vehicle 1.

Meanwhile, the first distribution unit 310 and the second distribution unit 320 of the air conditioner for the vehicle 1 according to embodiments of the present disclosure have the separation plate 400 formed on each central portion and are divided into a left distribution unit (not shown) and a right distribution unit (not shown), in which the left distribution unit (not shown) may be connected to the air conditioning duct disposed on the left seat of the vehicle 1 and the right distribution unit (not shown) may be connected to the air conditioning duct disposed on the right seat of the vehicle 1.

Here, the separation plate 400 may be understood as meaning that the separation plate 400 formed on the central portion of each of the cold wind flow path 211 and the warm wind flow path 221 is formed to extend up to the first distribution unit 310 and the second distribution unit 320 as described above. In other words, the air separately flowing from the cold wind flow path 211 and the warm wind flow path 221 to the left air flow path 410 and the right air flow path 420 to flow into the distribution unit separately flows into the left distribution unit (not shown) and the right distribution unit (not shown) even inside the distribution unit, and thus is discharged to the air conditioning duct disposed on the left seat or the right seat of the vehicle 1.

Specifically, the separation plate 400 formed on the central portion of each of the first distribution unit 310 and the second distribution unit 320 separates each distribution unit into the left distribution unit (not shown) and the right distribution unit (not shown) so that each distribution unit may be connected to the air conditioning duct disposed on the left seat or the right seat of the vehicle 1.

In addition, as described above, since the first distribution unit 310 has one side connected to the first flow path 212 and each outlet of the warm wind flow path 221 and the other side connected to the air conditioning duct disposed on the front seat 30 of the vehicle 1, the air passing through the first door unit 231 and the second door unit 232 may be provided to the front seat 30 of the vehicle 1 and at the same time, the air may be individually provided to both the left and right of the front seat 30.

Likewise, as described above, since the second distribution unit 320 has one side connected to the warm wind flow path 221 and the second flow path 213 and the other side connected to the air conditioning duct disposed on the rear seat 40 of the vehicle 1, the air passing through the second door unit 232 may be provided to the rear seat 40 of the vehicle 1 and at the same time, the air may be individually provided to both the left and right of the rear seat 40.

Meanwhile, the door unit 230 of the air conditioner for the vehicle 1 according to embodiments of the present disclosure may be formed in a plate-shaped flat shape and installed to be slidable vertically to adjust the opening amount of the air flowing into the cold wind flow path 211 and the warm wind flow path 221 in the sliding direction, or formed in a fan-shaped dome shape or a propeller-shaped rotary shape and rotatably installed to adjust the opening amount of the air flowing into the cold wind flow path 211 and the warm wind flow path 221 according to a rotation angle.

In other words, the door unit 230 may be formed in any one of the flat shape, the dome shape, and the rotary shape, as necessary. FIG. 1 shows that the first door unit 231 is formed in the flat shape, the second door unit 232 is formed in the rotary shape, and the third door unit 233 is formed in the dome shape, but they are not necessarily limited to being formed in these shapes, and may be differently formed according to design needs. In other words, this is merely the exemplary shapes to help the understanding of embodiments of the present disclosure, and the content of the present disclosure should not be regarded as being limited by the shapes of these drawings.

When the door unit 230 is formed in the plate-shaped flat shape, the door unit 230 may be installed to be slidable vertically. Accordingly, since a large area may be opened and closed with a minimum configuration, there is the most advantageous effect in terms of cost saving.

When the door unit 230 is formed in the fan-shaped dome shape or the propeller-shaped rotary shape, the door unit 230 may be rotatably installed within a certain angle. Accordingly, it is possible not only to open and close the cold wind flow path and the warm wind flow path 221 with one door unit 230 but also to selectively mix cold air and warm air.

In particular, the door unit 230 formed in the fan-shaped dome shape may not only prevent durability performance from being reduced by the overload of a rotational shaft caused by the introduction of the air upon the rotation operation, but may also increase the contact area with the inlet or outlet of each flow path when the cold wind flow path 211 and the warm wind flow path 221 are fully opened or closed, thereby increasing the sealing effect.

For reference, it is natural that the door unit 230 of the air conditioner for the vehicle 1 according to embodiments of the present disclosure may be slid or its rotation angle may be adjusted by a drive motor (not shown) operated by a separate control unit (not shown).

FIG. 7 is a diagram showing the internal structures of the air conditioning unit 200 and the distribution unit 300 according to another embodiment of the present disclosure.

Referring to FIG. 7, in the air conditioner for the vehicle according to embodiments of the present disclosure, the heater 220 may include a capacitor 222 and a PTC heater 223, and the PTC heater 223 may be separated from the air conditioning unit 200 and provided in the distribution unit 300.

As mentioned above, the PTC heater 223 may fundamentally block the risk of overheating even without a separate control because it may perform the sensor function by itself due to the nature of the PTC element, and thus is mainly used as an auxiliary heater for a vehicle.

However, there is a problem in that when the PTC heater 223 is provided in the air conditioning unit 200, heat loss is increased when the air is heated through the PTC heater 223 as the air conditioning unit 200 is disposed outside the vehicle with respect to the dash panel of the vehicle. In addition, as the load of the PTC heater 223 itself is added to the air conditioning unit 200, considerable difficulties may occur in the process in which an operator mounts or assembles the air conditioning unit 200 to the vehicle.

Accordingly, the air conditioner for the vehicle according to embodiments of the present disclosure intends to minimize the heat loss and improve ease of operation of the operator by providing the capacitor 222 among the components of the heater 220 in the air conditioning unit 200 but providing the PTC heater 223 in the distribution unit 300 separately from the air conditioning unit 200.

For reference, even when the PTC heater 223 is provided in the distribution unit 300, according to embodiments of the present disclosure, the distribution unit 300 is initially disposed inside the vehicle, so that as the PTC heater 223 is added, the use of the inside space of the vehicle is not reduced.

Even when the inside space of the vehicle is somewhat narrowed due to the addition of the PTC heater 223, the above-described effects (minimization of heat loss and improvement in ease of operation) may be implemented even while securing the inside space as much as possible when a predetermined bend is formed along line B-B as shown in FIG. 7.

Accordingly, as described above, the air conditioner for the vehicle 1 according to embodiments of the present disclosure may dispose the air conditioning unit 200 and the blower unit 100 outside the vehicle and the distribution unit 300 inside the vehicle with respect to the dash panel 10 for the vehicle 1 to maximize the use of the inside space 20 of the vehicle 1, enable each of the air conditioning unit 200, the blower unit 100, and the distribution unit 300 to be individually detached to improve the manufacturing process and the efficiency of service, form the plurality of flow paths separated in the up-down direction and the left-right direction inside the air conditioning unit 200, and be provided with the door unit 230 configured to adjust the opening amount of the air flowing into each flow path, thereby individually controlling the temperature of the air discharged to the air conditioning ducts disposed on the front and rear seats and the left and right seats of the vehicle 1.

Although the specific embodiments of the present disclosure have been shown and described, it will be apparent to those skilled in the art that the present disclosure may be variously improved and changed without departing from the technical spirit of the present disclosure provided by the appended claims.

What is claimed is:

1. An air conditioner for a vehicle, the air conditioner comprising:
a blower unit disposed on an outer surface of a dash panel, the outer surface being opposite an inner surface that faces an interior space of the vehicle, the blower unit comprising a blower fan and a filter;
an air conditioning unit disposed on the outer surface of the dash panel and coupled to a side of the blower unit between the blower unit and the interior space of the vehicle; and
a distribution unit disposed on the inner surface of the dash panel and located between the air conditioning unit and air conditioning ducts provided in the interior space of the vehicle;
wherein each of the blower unit, the air conditioning unit, and the distribution unit is coupled to be individually detachable.

2. The air conditioner of claim 1, wherein the air conditioning unit comprises a cooler, a heater, a cold wind flow path provided with the cooler, and a warm wind flow path provided with the heater, and wherein the air conditioning unit is configured to divide air introduced from the blower unit into cold air and warm air and discharge the cold air and the warm air along the cold wind flow path and the warm wind flow path, respectively.

3. The air conditioner of claim 2, wherein the air conditioning unit further comprises a door unit disposed between the cold wind flow path and the warm wind flow path and individually provided on an inlet and an outlet of each flow path to adjust an opening amount of the air that flows into each flow path.

4. The air conditioner of claim 3, further comprising a first separation plate and a second separation plate disposed on a central portion of the cold wind flow path and the warm wind flow path, respectively, wherein the first and second separation plates separate the cold wind flow path and the warm wind flow path into a left air flow path and a right air flow path, the left air flow path configured to communicate with the air conditioning duct disposed on a left seat of the vehicle and the right air flow path configured to communicate with the air conditioning duct disposed on a right seat of the vehicle.

5. The air conditioner of claim 4, wherein the door unit is individually provided on an inlet and an outlet of each of the left air flow path and the right air flow path.

6. The air conditioner of claim 3, wherein the door unit has a plate-shaped flat shape and is installed to be slidable vertically to adjust the opening amount of the air that flows into the cold wind flow path and the warm wind flow path in a sliding direction.

7. The air conditioner of claim 3, wherein the door unit has a fan-shaped dome shape and is rotatably installed to adjust the opening amount of the air that flows into the cold wind flow path and the warm wind flow path according to a rotation angle.

8. The air conditioner of claim 3, wherein the door unit has a propeller-shaped rotary shape and is rotatably installed to adjust the opening amount of the air that flows into the cold wind flow path and the warm wind flow path according to a rotation angle.

9. The air conditioner of claim 2, wherein the heater comprises a condenser and a positive temperature coefficient (PTC) heater, the PTC heater being separated from the air conditioning unit and provided in the distribution unit.

10. The air conditioner of claim 2, wherein the cold wind flow path comprises a first flow path disposed above the warm wind flow path to communicate with the air conditioning duct disposed on a front seat of the vehicle and a second flow path disposed below the warm wind flow path to communicate with the air conditioning duct disposed on a rear seat of the vehicle.

11. The air conditioner of claim 10, wherein the distribution unit comprises:
a first distribution unit connected to the air conditioning duct disposed on the front seat of the vehicle; and
a second distribution unit connected to the air conditioning duct disposed on the rear seat of the vehicle.

12. The air conditioner of claim 11, wherein:
the first distribution unit and the second distribution unit are each separated into a left distribution unit and a right distribution unit by a separation plate disposed on a central portion of each; and
the left distribution unit is connected to the air conditioning duct disposed on a left seat of the vehicle and the right distribution unit is connected to the air conditioning duct disposed on a right seat of the vehicle.

13. The air conditioner of claim 10, wherein the air conditioning unit further comprises a door unit disposed between the cold wind flow path and the warm wind flow path and individually provided on an inlet and an outlet of each flow path to adjust an opening amount of the air that flows into each flow path, the door unit comprising:
a first door unit disposed between the first flow path and each inlet of the warm wind flow path;
a second door unit disposed between the first flow path and each outlet of the warm wind flow path; and
a third door unit disposed between the warm wind flow path and the second flow path.

14. A vehicle comprising:
a dash panel having an inner surface facing an interior space of the vehicle and an outer surface opposite the inner surface;
vehicle seats disposed in the interior space of the vehicle;
a blower unit disposed on the outer surface of the dash panel and comprising a blower fan and a filter;
an air conditioning unit disposed on the outer surface of the dash panel and coupled to a side of the blower unit between the blower unit and the interior space of the vehicle; and
a distribution unit disposed on the inner surface of the dash panel and located between the air conditioning unit and air conditioning ducts provided at the vehicle seats;
wherein each of the blower unit, the air conditioning unit, and the distribution unit is coupled to be individually detachable.

15. The vehicle of claim 14, wherein the air conditioning unit comprises a cooler, a heater, a cold wind flow path provided with the cooler, and a warm wind flow path provided with the heater, and wherein the air conditioning unit is configured to divide air introduced from the blower unit into cold air and warm air and discharge the cold air and the warm air along the cold wind flow path and the warm wind flow path, respectively.

16. The vehicle of claim 15, wherein the air conditioning unit further comprises a door unit disposed between the cold wind flow path and the warm wind flow path and individually provided on an inlet and an outlet of each flow path to adjust an opening amount of the air that flows into each flow path.

17. The vehicle of claim 16, further comprising a first separation plate and a second separation plate disposed on a central portion of the cold wind flow path and the warm wind flow path, respectively, wherein the first and second separation plates separate the cold wind flow path and the warm wind flow path into a left air flow path and a right air flow path, the left air flow path configured to communicate with the air conditioning duct disposed at a left seat of the vehicle seats and the right air flow path configured to communicate with the air conditioning duct disposed on a right seat of the vehicle seats.

18. The vehicle of claim 15, wherein the cold wind flow path comprises a first flow path disposed above the warm wind flow path to communicate with the air conditioning duct disposed at a front seat of the vehicle seats and a second flow path disposed below the warm wind flow path to communicate with the air conditioning duct disposed at a rear seat of the vehicle seats.

19. The vehicle of claim 18, wherein the distribution unit comprises:
a first distribution unit connected to the air conditioning duct disposed at the front seat of the vehicle seats; and
a second distribution unit connected to the air conditioning duct disposed at the rear seat of the vehicle seats.

20. An air conditioner for a vehicle, the air conditioner comprising:
a blower unit disposed on an outer surface of a dash panel, the outer surface being opposite an inner surface that faces an interior space of the vehicle, the blower unit comprising a blower fan and a filter;
an air conditioning unit disposed on the outer surface of the dash panel and coupled to a side of the blower unit, wherein the air conditioning unit is configured to introduce air from the blower unit and adjust a temperature of the air; and
a distribution unit disposed on the inner surface of the dash panel and configured to introduce the air having the adjusted temperature through the air conditioning unit and distribute the air having the adjusted temperature to air conditioning ducts provided in the interior space of the vehicle; and
wherein each of the blower unit, the air conditioning unit, and the distribution unit is coupled to be individually detachable.
